(19) United States
(12) Patent Application Publication
(10) Pub. No.: US 2022/0194651 A1
(43) Pub. Date: Jun. 23, 2022

(54) SPIRIT BOTTLE GREETING CARD

(71) Applicants: Daniel Cedrone, Marblehead, MA (US); William Hench, San Rafael, CA (US); Andrew Hench, Marblehead, MA (US)

(72) Inventors: Daniel Cedrone, Marblehead, MA (US); William Hench, San Rafael, CA (US); Andrew Hench, Marblehead, MA (US)

(21) Appl. No.: 17/247,655

(22) Filed: Dec. 18, 2020

(51) Int. Cl. B65D 1/40; B65D 1/02

(52) U.S. Cl. CPC B65D 1/40; B65D 1/0246

(57) ABSTRACT

A spirit bottle greeting card is configured to contain a small bottle of spirits as a gift for a recipient. The spirits are typically in 50 ml spirit bottle, a quantity of sufficient size for the sender to “toast” the occasion for the recipient. The spirit bottle greeting card includes a cover that is attached to a container with a hinge. A spirit bottle retainer is received in the container and suspends the spirit bottle within an interior cavity. The spirit bottle retainer has a recess to releasably and captively receive the spirit bottle. The recess has a neck portion to conform to a neck of the spirit bottle, a shoulder portion to conform to a shoulder of the spirit bottle, and a body portion to conform to a body of the spirit bottle. A plurality of retaining tabs hold the spirit bottle in a snap fit configuration.

### BACKGROUND OF THE INVENTION

The present invention relates to greeting cards, and more particularly to greeting cards with accompanying gifts.

Traditional greeting cards typically contain a printed message, characters, and the like to convey a greeting for various occasions, from Birthday wishes, Christmas wishes, graduations, and other occasions throughout the year.

More recently, greeting cards have been developed for carrying the traditional greeting along with a gift item, such as a check, cash, and gift cards carrying a cash value. Since these types of gifts are generally flat items, with dimensions less than most greeting cards, these gift carrying cards maintain the conventional characteristics of the traditional gift card, with the exception of a slot, sleeve, or other way of containing the gift item. However, there have been limited attempts to stray beyond the confines of conventional gift cards to contain an item of relatively larger thicknesses.

As can be seen, there is a need for an improved gift greeting card.

### SUMMARY OF THE INVENTION

In one aspect of the present invention, a spirit bottle greeting card is disclosed. The sprit bottle greeting card includes container having at least one sidewall and a bottom wall defining an interior cavity and a front face opening to the interior cavity. A cover has an outer face and an inner face. The cover is hingedly attached to the at least one sidewall along an edge of the front face opening. The cover is dimensioned to cover the front face opening when moved to a closed condition and provide access to the interior cavity in an open condition. A spirit bottle retainer is dimensioned to abut the at least one sidewall and suspend a spirit bottle within the interior cavity. The spirit bottle retainer has a recess dimensioned to releasably and captively receive the spirit bottle the recess.

In some embodiments, the recess includes a neck portion dimensioned to conform to a neck of the spirit bottle, a shoulder portion dimensioned to conform to a shoulder of the spirit bottle, and a body portion dimensioned to conform to a body of the spirit bottle. A plurality of retaining tabs protrude inwardly across a face of the recess. The plurality of retaining tabs are dimensioned to engage with a corresponding at least one of the neck, the shoulder, or the body of the spirit bottle and retain the spirit bottle in the recess in a snap-fit relation.

In some embodiments, a retractor slot is defined on an opposed edge of the recess and dimensioned to receive a digit of a user's hand to grasp the spirit bottle and retract the spirit bottle from the snap-fit relation within the recess. The retractor slot may be positioned along the body portion of the recess.

In some embodiments, a frame surrounds a peripheral side edge of the spirit bottle retainer to conform to the at least one sidewall. A frame depression is disposed between the frame and the recess, wherein the recess is defined in the frame depression.

In some embodiments, the frame supports the cover when moved to the closed condition.

In other embodiments, the spirit bottle is received in the recess.

In yet other embodiments, indicia are carried on at least one of the outer face and the inner face, the indicia corresponding to one of a plurality of greeting occasions. The indicia may also be carried on the at least one sidewall.

These and other features, aspects and advantages of the present invention will become better understood with reference to the following drawings, description and claims.

### BRIEF DESCRIPTION OF THE DRAWINGS

FIG. 1 is a perspective view spirit bottle greeting card.

FIG. 2 is a perspective view spirit bottle greeting card, shown with cover open.

FIG. 3 is an exploded view spirit bottle greeting card.

FIG. 4 is a section view taken along line 4-4 from FIG. 2.

FIG. 5 is a section view taken along line 5-5 from FIG. 2.

FIG. 6 is a section view taken along line 6-6 from FIG. 2.

FIG. 7 is an enlarged detailed view.

FIG. 8 is a section view taken along line 8-8 from FIG. 2.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide a gift card that is configured to contain a small bottle of spirits, or another beverage, as a gift for the intended recipient. The small bottle of spirits is typically on the order of 50 ml, a quantity of sufficient size for the sender to “toast” the occasion for the recipient of the card, while also conveying a greeting for the occasion.

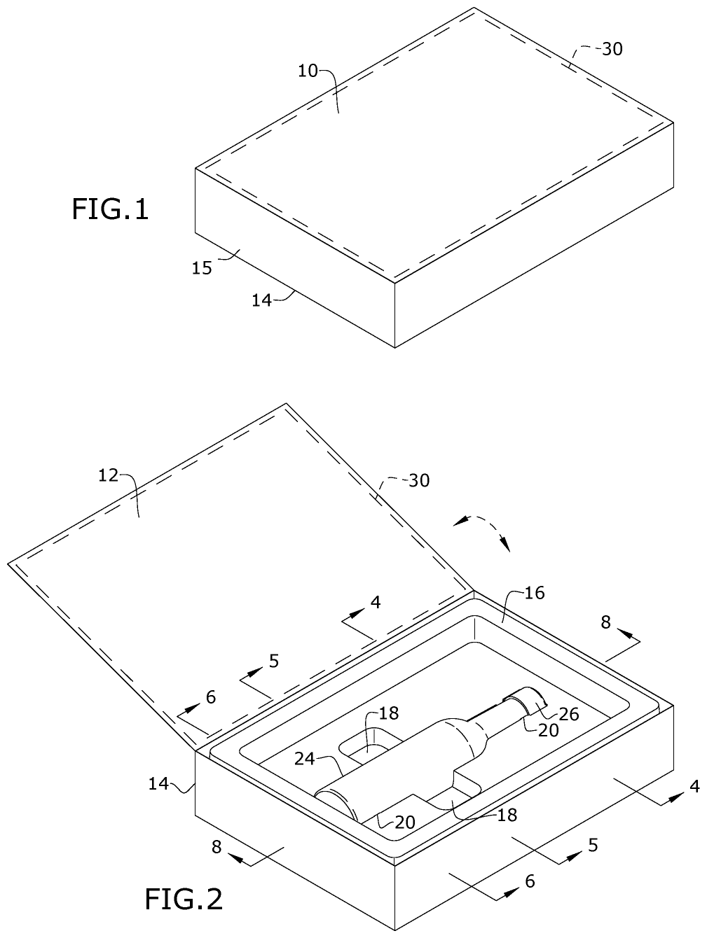

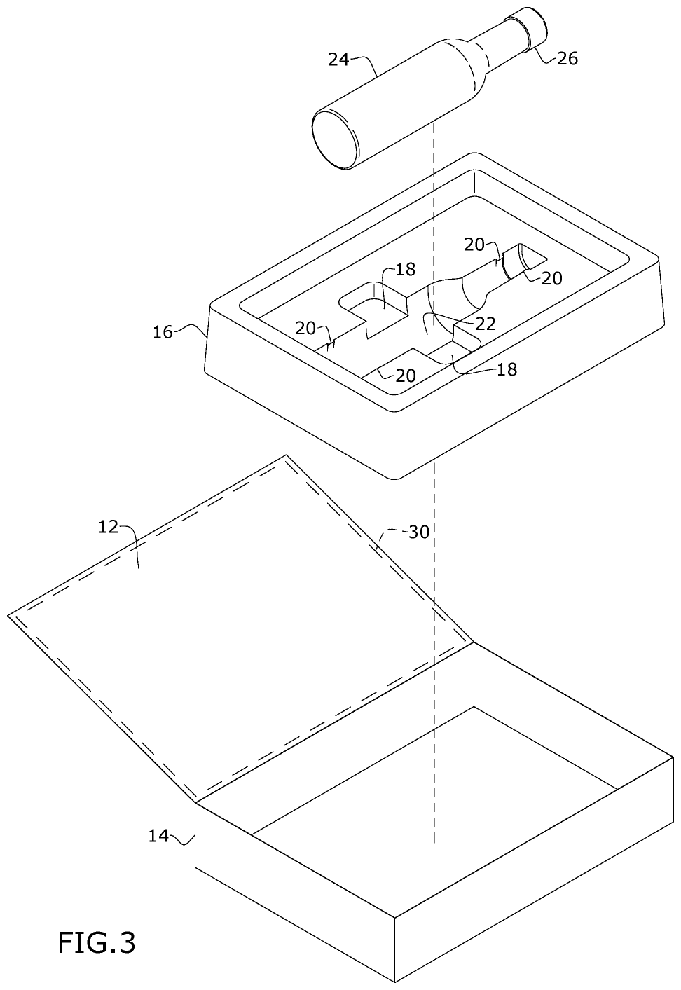

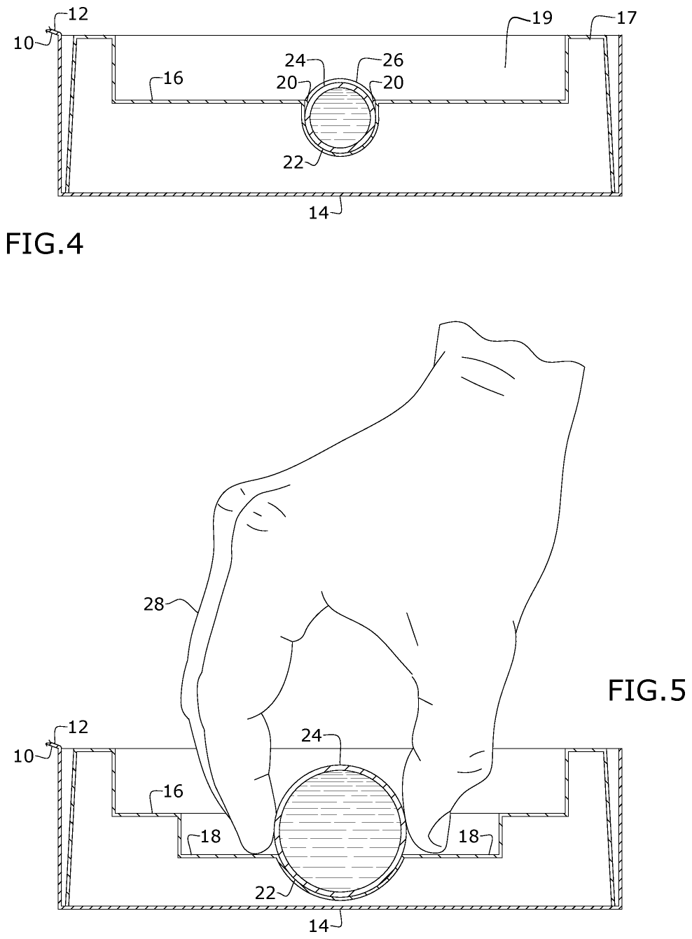

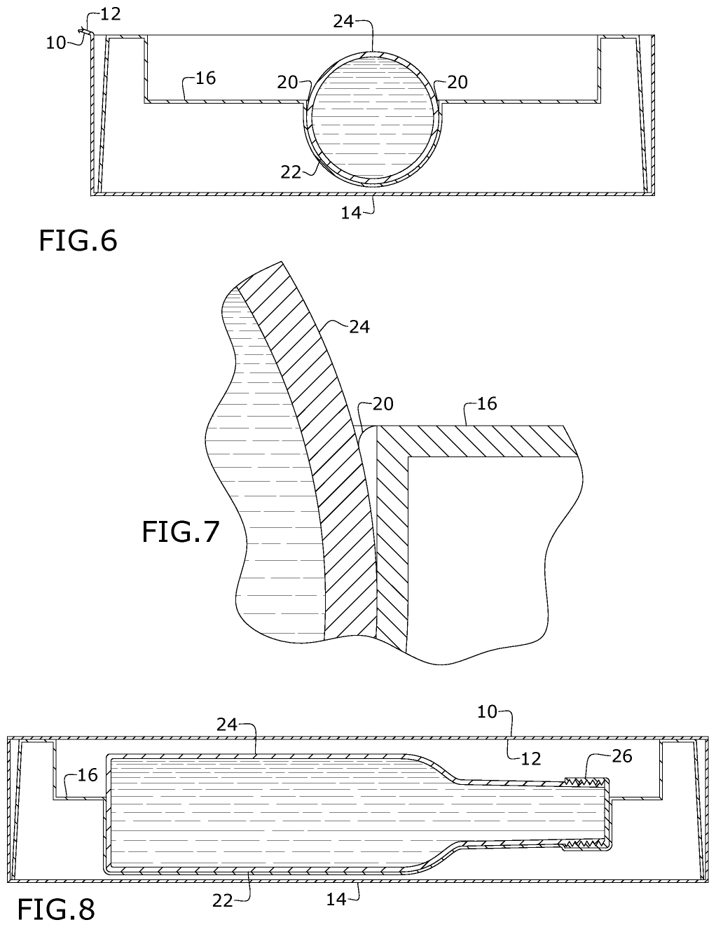

As seen in reference to the drawings of FIGS. 1-8, spirit bottle greeting card includes a cover having an outer face 10 and an inner face 12. The cover is hingedly attached a container 14 having at least one sidewall 15 along an edge of a front face opening. The cover is dimensioned to cover the front face opening when moved to a closed condition and provide access to an interior cavity of the container 14 in an open condition.

The container 14 has at least one sidewall 15 and a bottom wall defining an interior cavity. The front face opening provides user access to the interior cavity.

A spirit bottle retainer 16 dimensioned to abut the at least one sidewall 15 and suspend a spirit bottle 24 within the interior cavity. The spirit bottle retainer 16 has a recess 22 that is dimensioned to releasably and captively receive the spirit bottle 24 the recess 22. Preferably, the recess 22 has a neck portion dimensioned to conform to a neck or a cap 26 of the spirit bottle 24, a shoulder portion that is dimensioned to conform to a shoulder of the spirit bottle 24, and a body portion dimensioned to conform to a body of the spirit bottle 24. In the non-limiting embodiment show, the sprit bottle 24 and recess 22 are shown as corresponding to a cylindrical sprit bottle 24. As will be appreciated, the shape of the spirit bottle 24 may take on any number of configurations. Consequently, the corresponding recess 22 will be dimensioned to other bottle configurations.

A plurality of retaining tabs 20 protruding inwardly across a face of the recess 20. The plurality of retaining tabs 20 are dimensioned to engage with a corresponding at least one of the neck, the shoulder, or the body of the spirit bottle 24 and retain the spirit bottle 24 in the recess in a snap-fit relation. The retaining tabs 20 may have a first rounded portion with a narrow radius of curvature, while a second rounded portion has a broader radius of curvature ton conform with a side wall of the spirit bottle 24.

A retractor slot 18 is defined on an opposed edge of the recess 22. The retractor slot 18 is dimensioned to receive a digit of a user's hand 28 to grasp the spirit bottle 24 and retract the spirit bottle 24 from the snap-fit relation within the recess. Preferably, the retractor slot 18 is positioned along the body portion of the recess 22 to provide the user 28 a better gripping action on the spirit bottle 24.

The spirit bottle retainer 16 may include a frame 17 surrounding a peripheral side edge of the spirit bottle retainer 16 to conform to the at least one sidewall 15 of the container. A frame depression 19 may be disposed between the frame 17 and the recess 22 with the recess 22 is defined in a bottom surface of the frame depression 19. The frame 17 supports the inner face 12 of the cover when moved to the closed condition.

As will be appreciated, indicia may be carried on a design area 30 of at least one of the outer face 10 and the inner face 12 of the cover. The indicia are selected to correspond with at least one of a plurality of greeting occasions. The indicia may also be carried on the at least one sidewall 15.

It should be understood, of course, that the foregoing relates to exemplary embodiments of the invention and that modifications may be made without departing from the spirit and scope of the invention as set forth in the following claims.

What is claimed is:

1. A spirit bottle greeting card, comprising:
a container having at least one sidewall and a bottom wall defining an interior cavity, with a front face opening to the interior cavity;
a cover having an outer face and an inner face, the cover hingedly attached to the at least one sidewall along an edge of the front face opening, the cover dimensioned to cover the front face opening when moved to a closed condition and provide access to the interior cavity in an open condition, and
a spirit bottle retainer dimensioned to abut the at least one sidewall and suspend a spirit bottle within the interior cavity; the spirit bottle retainer having a recess dimensioned to releasably and captively receive the spirit bottle the recess.

2. The spirit bottle greeting card of claim 1, wherein the recess further comprises:
a neck portion dimensioned to conform to a neck of the spirit bottle;
a shoulder portion dimensioned to conform to a shoulder of the spirit bottle; and
a body portion dimensioned to conform to a body of the spirit bottle.

3. The spirit bottle greeting card of claim 2, further comprising:
a plurality of retaining tabs protruding inwardly across a face of the recess, the plurality of retaining tabs dimensioned to engage with a corresponding at least one of the neck, the shoulder, or the body of the spirit bottle and retain the spirit bottle in the recess in a snap-fit relation.

4. The spirit bottle greeting card of claim 3, further comprising:
a retractor slot defined on an opposed edge of the recess dimensioned to receive a digit of a user's hand to grasp the spirit bottle and retract the spirit bottle from the snap-fit relation within the recess.

5. The spirit bottle greeting card of claim 4, wherein the retractor slot is positioned along the body portion of the recess.

6. The spirit bottle greeting card of claim 1, further comprising:
a frame surrounding a peripheral side edge of the spirit bottle retainer to conform to the at least one sidewall; and
a frame depression disposed between the frame and the recess, wherein the recess is defined in the frame depression.

7. The spirit bottle greeting card of claim 6, wherein the frame supports the cover when moved to the closed condition.

8. The spirit bottle greeting card of claim 1, further comprising:
the spirit bottle received in the recess.

9. The spirit bottle greeting card of claim 1, further comprising:
indicia carried on at least one of the outer face and the inner face, the indicia corresponding to one of a plurality of greeting occasions.

10. The spirit bottle greeting card of claim 9, further comprising:
the indicia are carried on the at least one sidewall.
